(19) United States
(12) Patent Application Publication
(10) Pub. No.: US 2026/0015057 A1
(43) Pub. Date: Jan. 15, 2026

(54) BICYCLE CARGO CARRIER

(71) Applicant: Paul Francis Mirto, Dalton, MA (US)

(72) Inventor: Paul Francis Mirto, Dalton, MA (US)

(21) Appl. No.: 19/053,031

(22) Filed: Feb. 13, 2025

Related U.S. Application Data
(60) Provisional application No. 63/669,960, filed on Jul. 11, 2024.

(51) Int. Cl. B62J 7/04

(52) U.S. Cl. CPC B62J 7/04

(57) ABSTRACT

A bicycle cargo carrier comprises a pair of side panels extending obliquely upward from a base, forming a V-shaped space therebetween. The side panels include openings proximate upper edges thereof, which can comprise closed holes, holes connected by passages to the upper edges, and/or notches. An anchoring loop and/or base plate can be provided proximate the rear bicycle axle. Side support panels can comprise holes proximate outer edges thereof, through which cords extend, creating stowage spaces proximate the side panels. A cargo-carrying bag can be attached by inserting bag handles into selected openings, or by attaching cords to the bag and the openings. A cord can be attached to the anchoring loop or base plate, extended over the bag, and attached to an opening. Cargo can be placed in the V-shaped space and held in place by straps and/or cords attached to, or surrounding, the side panels.

### RELATED APPLICATIONS

This application claims the benefit of U.S. Provisional Application No. 63/669,960, filed Jul. 11, 2024, which is herein incorporated by reference in its entirety for all purposes.

### FIELD OF THE INVENTION

The invention relates to accessories for bicycles, and more particularly, to cargo carrying racks for bicycles.

### BACKGROUND OF THE INVENTION

Bicycles are a popular mode of transportation throughout the world. They are light in weight, do not require fuel, do not harm the environment, and are relatively inexpensive to purchase and operate, as compared to motor vehicles. Depending on the terrain, a bicycle can be ridden for pleasure, exercise, and/or competition. In addition, a bicycle can provide convenient transportation, as an alternative to a motor vehicle, when traveling distances of up to 10 miles or more. For example, a bicycle can be a convenient means to travel to an office or other place of work, or to and from a store, especially when the weather is fair.

However, when traveling by bicycle, it can be difficult to transport cargo, such as a briefcase, a shopping bag, a box, or a large bottle of water, because a bicycle provides few options for attaching cargo thereto. One approach is to hang a basket from the handlebars. However, if the cargo is heavy, steering of the bicycle can be impeded.

With reference to FIGS. 1A and 1B, a more common approach is to attach a “rack” 100 to the rear of the bicycle 102. Typically, the rack 100 is attached by struts 110 to the rear axle 104 of the bicycle, and optionally also to the underside of the seat 112, and provides a flat, horizontal, narrow top just above the rear wheel 108. In FIG. 1A, the top 106 of the rack 100 comprises a “clip-in” mount 106, whereas in FIG. 1B, the top 106 of the rack 100 comprises a “center-slide” mount 116.

Substantially rigid items, such as books or a briefcase, can be placed on the top of the rack, and fastened thereto, either using a mounting feature 106, 116 and/or, for example, by wrapping elastic “bungee” cords around the cargo and the rack 100. If larger and/or less rigid cargo is to be carried, a basket or other cargo container can be attached to the flat top of the bicycle, and/or to panniers, for example by cords, hook-and-loop straps, and/or an interlocking mechanism between the bottom of the cargo container and the flat top of the rack 100.

However, these approaches have the disadvantage that the cargo is stowed in an elevated location above the rear wheel, thereby raising the center of gravity and magnifying the tipping movements of the bicycle 102, for example whenever the bicycle 102 is turning. If the cargo is heavy, it may tend to shift away from the centerline of the bicycle 102 by sliding to the side of a simple and inexpensive cargo container, such as an open basket. And if the cargo container is more sophisticated, for example if the cargo container includes multiple internal pouches and hook-and-loop straps, it will be costly, and will require significant manipulation when loading the cargo therein. Furthermore, regardless of how the cargo is mounted to the rack, if the cargo is heavy it may tend to unbalance the bicycle 102 when it is turning or otherwise tipping.

Another approach is to provide panniers 114, 116 or saddle-bags, positioned for mounting 114 and positioning 116 bags or other cargo that attach to the cargo rack and hang downward from the rack 100 on either side of the rear wheel. This approach has the advantage of lowering the center-of-mass of the cargo below the rack 100. However, panniers 106, 116 and saddle bags can be inconvenient or ineffective if the cargo does not fit well into the spaces provided in the panniers 106, 116 or saddle bags. For example, it can be necessary to unload groceries or other purchased items from a bag provided by a store, and then stow them separately within the saddle bags or panniers, assuming that there is sufficient space in the saddlebag or pannier to accommodate all of the items.

What is needed, therefore, is a bicycle cargo carrier that can be quickly and conveniently loaded and unloaded, minimizes unbalancing of the bicycle when turning or otherwise tipping, and limits any shifting of the cargo away from the centerline of the bicycle.

### SUMMARY OF THE INVENTION

The present invention is a bicycle cargo carrier that can be quickly and conveniently loaded and unloaded, minimizes unbalancing of the bicycle when turning or otherwise tipping, and limits any shifting of the cargo away from the centerline of the bicycle.

Rather than providing a flat-bottomed cargo carrying space, the disclosed cargo carrier comprises a pair of side panels that extend upward from an underlying horizontal base at symmetric, acute angles, forming a “V” shaped cargo carrying space therebetween. In embodiments, the side panels form a right angle therebetween. At least one pair of openings, such as holes or notches, is provided at the top of each of the side panels, with the openings being configured to enable cargo to be suspended from upper edges of the side panels and positioned beside the rear wheel of the bicycle, and/or placed in the “V” between the side panels and held in place by ropes, cords, straps, or other surrounding means, generically referred to herein as “cords.”

Embodiments are configured to attach the handles of a conventional carrying bag, such as a paper, plastic, or canvas bag provided by a grocery store or other retailer (generically referred to herein as a “tote bag,” or simply as a “bag”), to the upper edges of the side panels, thereby suspending the tote bag below and to the side of the cargo carrier, and locating the center of mass of the tote bag below the base of the cargo carrier, minimizing any unbalancing of the bicycle during turns and other tipping events, and eliminating, in many cases, any need to transfer purchased items from the retailer's bag to a separate cargo carrier. Attachment cords can also be provided as part of a tote bag that is specifically intended for use with the disclosed invention, or separate cords can be extended through grommets provided on the tote bag and used to attach the tote bag to the cargo carrier. Cords extending from the upper edges of the side panels to an attachment point near the hub of the rear wheel can be used to prevent the tote bag from swinging outward from the side of the bicycle.

Cargo can also be stowed above the carrier base between the side panels. The center-of-mass of such cargo is located above the carrier base, but the V-shaped cargo space between the side panels naturally maintains the cargo centered over the rear wheel, and prevents the cargo from shifting away from the centerline of the bicycle, even when the bicycle is turning or otherwise tipping. In various embodiments, ropes, buckled straps, hook-and-loop straps, and/or cords can extend over the cargo and hold it in place. In some embodiments, the juncture of the side panels is raised above the base of the cargo carrier, thereby providing a space through which a rope, strap, or cord can be extended, so that it loops entirely about the side panels and the cargo.

A first general aspect of the present invention is a cargo carrier that is attachable to a rear-wheel rack of a bicycle. The cargo carrier includes a horizontal base configured for attachment thereof to the rear-wheel rack, longitudinal left and right side panels extending obliquely and symmetrically upward from a central juncture between lower edges thereof, a V-shaped carrying space being formed between the side panels, the central juncture extending longitudinally in vertical alignment with a rear wheel of the bicycle, and a plurality of upper openings provided proximate upper edges of the left and right side panels.

In embodiments, the left and right side panels are inclined from vertical by angles of 45 degrees and −45 degrees, respectively, thereby forming a right angle at the central juncture therebetween.

In any of the above embodiments, at least one of the upper openings can include a hole and a passage that extends from the hole to the upper edge of the left side panel or the right side panel.

In any of the above embodiments, at least one of the upper openings can include a hole, a horizontal passage having a proximal end extending horizontally from the hole, and a vertical passage extending vertically from a distal end of the horizontal passage to the upper edge of the left side panel or the right side panel.

In any of the above embodiments, at least one of the upper openings can be a notch extending downward from the upper edge of the left side panel or the right side panel.

Any of the above embodiments can further include at least one side opening provided on at least one of a front side edge and a rear side edge of the left side panel or the right side panel.

In any of the above embodiments, the upper openings can include a longitudinally extending oval penetration proximate the upper edge of the right side panel or the left side panel.

In any of the above embodiments, the upper openings can include a plurality of pairs of identically shaped, horizontally aligned openings provided proximate the upper edges of the left and right side panels.

In any of the above embodiments, the central juncture can be vertically spaced above the horizontal base, forming a gap therebetween.

Any of the above embodiments can further include at least two longitudinally spaced apart left side supports extending between the left side panel and the horizontal base, and two longitudinally spaced apart right side supports extending between the right side panel and the horizontal base. In some of these embodiments each of the side supports comprises at least one hole proximate an outer edge thereof, and wherein the cargo carrier further comprises a side cord inserted through said holes and extending longitudinally therebetween, the side cord being thereby positioned above the horizontal base and latitudinally spaced apart from the side panels.

Any of the above embodiments can further include an anchoring loop configured for attachment thereof to a side of the bicycle proximate a rear axle thereof, the anchoring loop being configured for attachment thereto of a cord extending upward therefrom to one of the openings in the left or the right side panel.

Any of the above embodiments can further include an anchoring base plate penetrated by a base plate opening and configured for attachment thereof to a side of the bicycle proximate a rear axle thereof, the anchoring base plate being configured for attachment thereto of a cord extending upward therefrom to one of the upper openings on the left or the right side panel.

A second general aspect of the present invention is a method of transporting cargo on a bicycle to a destination. The method includes providing a bicycle having a rear wheel rack mounted thereto, providing a cargo carrier according to any embodiment of the first general aspect, attaching the horizontal base of the cargo carrier to the rear wheel rack, attaching the cargo to the cargo carrier, and riding by a user of the bicycle to the destination.

In embodiments, attaching the cargo to the cargo carrier comprises placing at least some of the cargo in a bag, and attaching the bag to at least two selected openings included in the upper openings, all of the selected openings being provided on the left side panel, or all of the selected openings being provided on the right side panel. In some of these embodiments, attaching the bag to the selected openings comprises inserting at least one looped handle of the bag into the selected openings. In any of these embodiments, attaching the bag to the selected openings can include attaching at least one cord to the bag and to at least one of the selected openings. In any of these embodiments, the cargo carrier can include an anchoring loop or an anchoring base plate attached to a side of the bicycle proximate a rear axle thereof, and attaching the bag to the selected openings can include attaching a cord to the anchoring loop or anchoring base plate, extending the cord over the bag, and attaching the cord to one of the selected openings.

In any of the above embodiments, attaching the cargo to the cargo carrier can include placing the at least some of the cargo into the V-shaped carrying space between the side panels, extending a cord or strap over the cargo, and attaching the cord or strap to the cargo carrier. In some of these embodiments, attaching the cord or strap to the cargo carrier includes one of attaching ends of the cord or strap to at least one of the upper openings provided on the left side panel and at least one of the upper openings provide on the right side panel, and extending the cord or strap through a space provided between the central juncture and the horizontal base, and attaching the ends of the cord or strap to each other, such that the cord or strap encircles the side panels and the cargo.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is perspective rear view of a bicycle comprising a rear-wheel bicycle rack having a clip-in mount;

FIG. 1B is perspective rear view of a bicycle comprising a rear-wheel bicycle rack having a center slide mount;

FIG. 2A is a perspective rear view, drawn to scale, of an embodiment of the present invention attached to the bicycle rack of FIG. 1;

FIG. 2B is a perspective rear view, drawn to scale, of the embodiment of FIG. 2A;

FIG. 2C is a rear view from above, drawn to scale, of the embodiment of FIG. 2A mounted to a rear wheel bicycle rack;

FIG. 3A is an exploded view, drawn to scale, of the embodiment of FIG. 2A shown with attachment hardware configured for attaching the horizontal base of the embodiment to the bicycle rack of FIG. 1A;

FIG. 3B is an exploded view, drawn to scale, showing attachment of the embodiment of FIG. 3A to the bicycle rack of FIG. 1A;

FIG. 4 is a perspective side view, drawn to scale, of an embodiment of the invention showing side stowage spaces created by a cord that extends through holes provided near outer edges of the side support panels;

FIG. 5A is a perspective view from above, drawn to scale, showing partial attachment of a bag to the embodiment of FIG. 2A by inserting a cordage line of the bag into openings provided at the upper edges of the side panels;

FIG. 5B is a perspective view from above, drawn to scale, showing full attachment of the bag of FIG. 5A to the embodiment of FIG. 2A;

FIG. 5C is a perspective view from above, drawn to scale, showing partial attachment of a bag to the embodiment of FIG. 2A by inserting a carrying handle of the bag into openings provided at the upper edge of the left side panel;

FIG. 5D is a perspective view from the rear, drawn to scale, showing two bags fully attached on either side of the illustrated embodiment by inserting both carrying handles of each of the bags into openings provided on the upper edges of the side panels;

FIGS. 6A-6C are a series of images, drawn to scale, that illustrate attachment of a cord knotted into a loop, such as a synthetic braided cord or a nylon cord, to a grommeted hole provided in a cargo bag;

FIG. 6D is a rear perspective view, drawn to scale, of the bag of FIGS. 6A-6C partially attached to the embodiment of FIG. 2A by the knotted cords;

FIG. 6E is a rear perspective view, drawn to scale, of the bag of FIGS. 6A-6C fully attached to the embodiment of FIG. 2A by the knotted cords;

FIG. 7A is a close-up view, drawn to scale, of an anchoring loop attached to a support strut of the bicycle rack of FIG. 1A near the rear axle of the bicycle;

FIG. 7B is a close-up view, drawn to scale, of an opening provided in a base plate of the cargo carrier of FIG. 1A near the rear axle of the bicycle;

FIGS. 8A-8D are a series of images, drawn to scale, that illustrate attachment of a bungee cord terminated by a large ball to the anchoring loop of FIG. 7A;

FIGS. 8E-8H are a series of images, drawn to scale, that illustrate attachment of a bungee cord terminated by a large ball to the base plate of FIG. 7B;

FIG. 9A is an image, drawn to scale, of a pair of bungee cords prepared for insertion through slots into openings provided near the upper edges of the side panels of an embodiment of the present invention;

FIG. 9B is an image, drawn to scale, of the bungee cords of FIG. 9A fully inserted into the openings provided near the upper edges of the side panels;

FIG. 9C is a rear perspective view, drawn to scale, of the bag of FIG. 5C attached to an embodiment of the present invention, wherein the bag is further stabilized by the bungee cords of FIG. 9B extending from the anchoring loop of FIG. 7A over the bag to the openings provided in the upper side panels of the cargo carrier;

FIG. 10A is a rear perspective view, drawn to scale, showing a round plastic bottle stowed in the V-shaped carrying space between the side panels of the disclosed cargo carrier and held in place by over-arching bungee cords attached to the side panels;

FIG. 10B is a perspective view, drawn to scale, of the bungee cords of FIG. 10B partially attached to the cargo carrier;

FIG. 10C is a perspective view, drawn to scale, of the bungee cords of FIG. 10B fully attached to the cargo carrier;

FIG. 11A is a perspective view, drawn to scale, of bungee cords being attached to an embodiment of the present invention in an inverted configuration;

FIG. 11B is a rear perspective view, drawn to scale, of the bags of FIG. 5C attached to a bicycle by the bungee cords of FIG. 11A;

FIG. 12A is a rear perspective view, drawn to scale, showing a box stowed in the V-shaped carrying space between the side panels of an embodiment of the present invention and held in place by an over-arching strap attached to the side panels; and

FIG. 12B is a perspective view, drawn to scale, of the strap of FIG. 12A installed in the cargo carrier and prepared for attachment of the box.

### DETAILED DESCRIPTION

The present invention is a bicycle cargo carrier that can be quickly and conveniently loaded and unloaded, minimizes unbalancing of the bicycle when turning or otherwise tipping, and limits any shifting of the cargo away from the centerline of the bicycle.

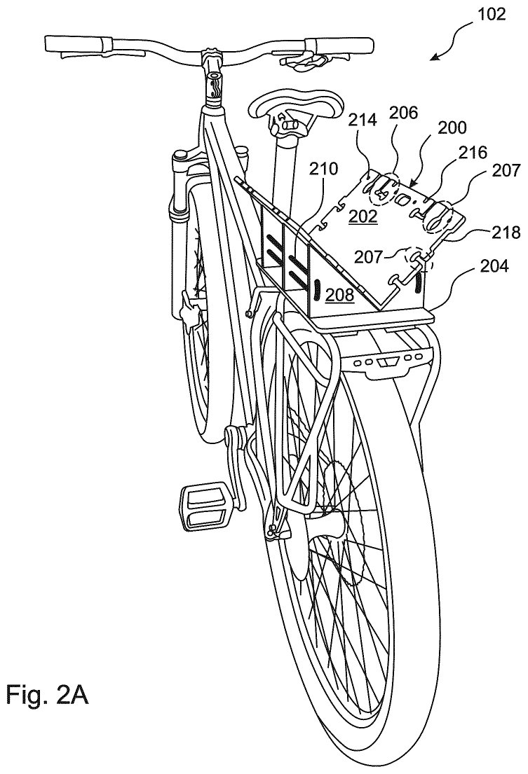

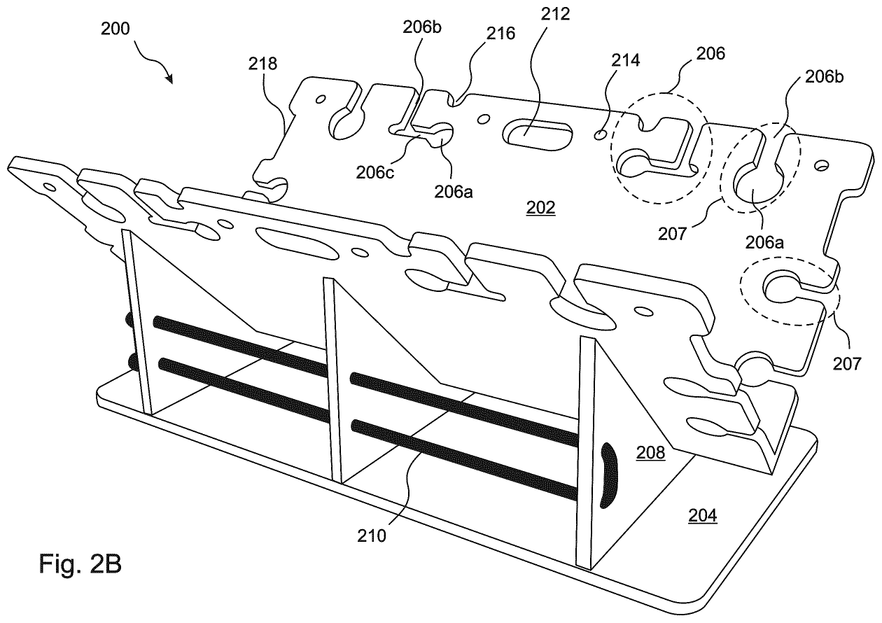

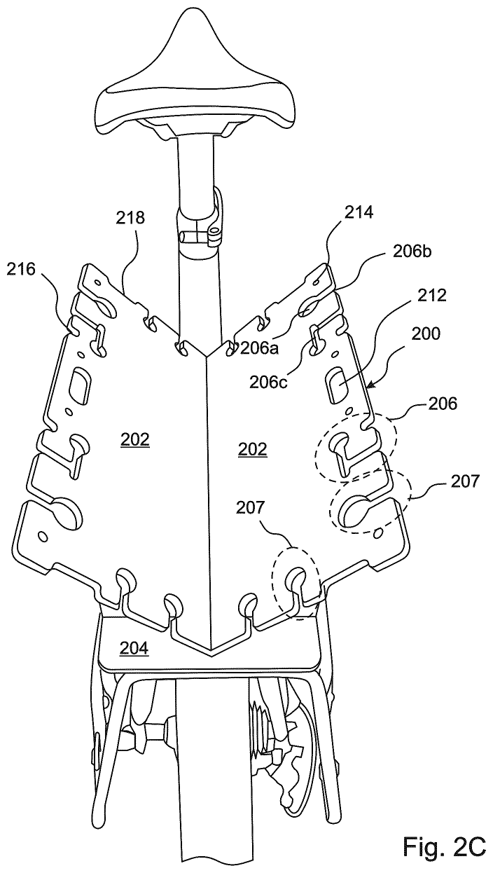

With reference to FIGS. 2A, 2B, and 2C, rather than providing a flat-topped carrier carrying space, the disclosed cargo carrier 200 comprises a pair of side panels 202 that extend upward from an underlying horizontal base 204 at symmetric, acute angles, forming a “V” shaped cargo carrying space therebetween. In the illustrated, exemplary embodiment, these “V” side panels 202 form a right angle therebetween. At least one pair of openings 206, 207, 212, 214 is provided proximate the upper edge of each of the side panels 202. In the illustrated embodiment, the upper edge of each of the side panels 202 comprises a plurality of openings 206, 207, 212, 214 that provide highly versatile attachment of a wide variety of cargo. The plurality of openings 206, 207, 212, 214 in the illustrated embodiment include a large, oval, central opening 212 and several smaller holes 214. Four of the openings 206, 207 include a vertical passage or slot 206b extending from a hole 206a to the upper edge of the side panel 202. For two of these openings 207, the vertical slot extends directly from the hole 206a to the upper edge of the side panel 202, while the other two of these openings 206 further include horizontal slots 206c that connect the hole 206a to the vertical slot 206b. Side openings 207 having similar shapes are included on the front and rear edges of the side panels 202. In addition to the openings 206, 207, 212, 214, notches 216 are provided along the upper edges of the side panels 202, and a wider notch 218 is provided on each side of each of the side panels.

As can be seen in FIGS. 2A and 2B, each of the side panels 202 in the illustrated embodiment is supported by a group of three spaced-apart side supports 208. In the exemplary embodiment, each of the side supports 208 is penetrated by two holes, located near outer edges of the side supports 208, through which a cord 210, which is knotted at both ends, extends in an elongated, sideways “U” shape. In embodiments, the cord 210 is an elastic cord 210.

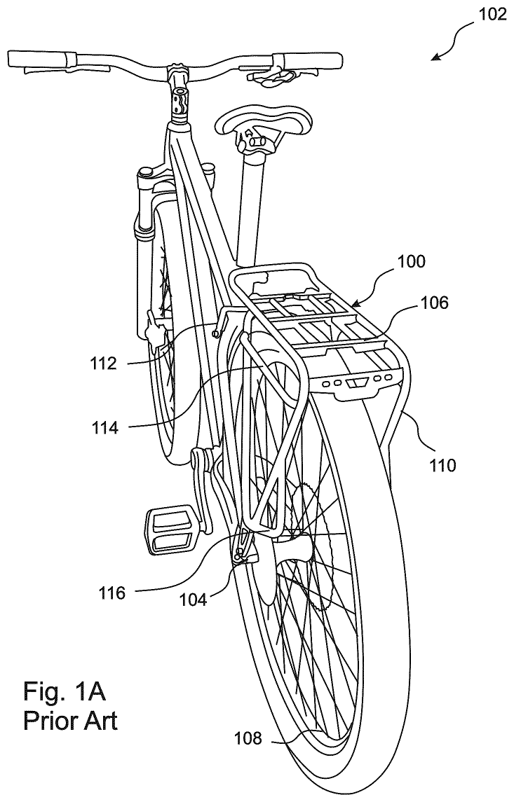

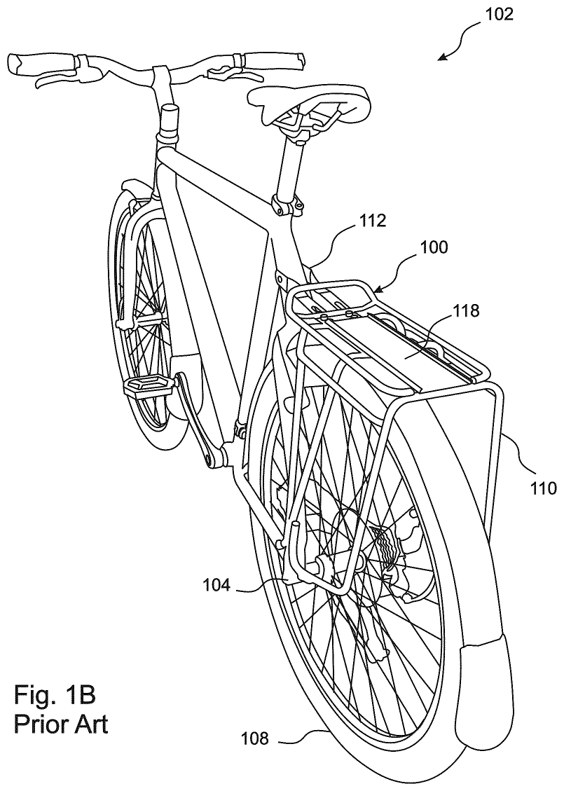

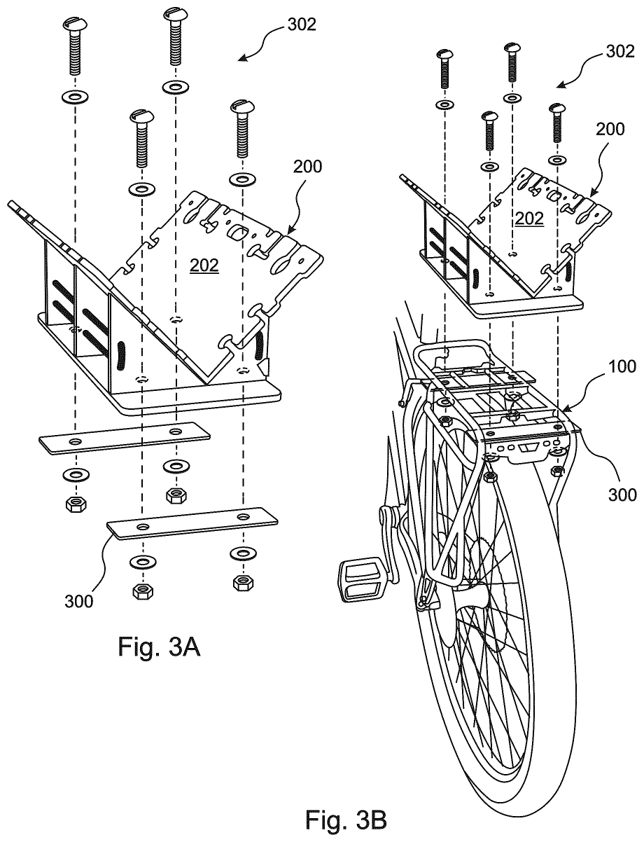

FIGS. 3A and 3B are exploded perspective views that illustrate attachment, via brackets 300 and associated attachment hardware 302, of the cargo carrier 200 of FIGS. 2A through 2C to the conventional bicycle cargo rack 100 of FIG. 1A.

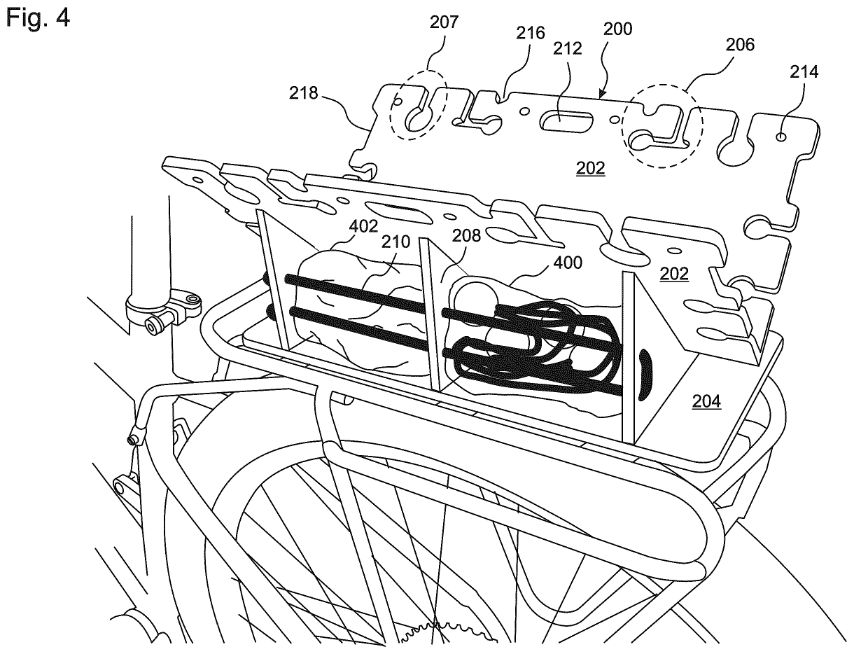

As can be seen in FIG. 4, the elastic cords 210 that extend through holes provided in the side supports 208 provide small enclosed spaces where items such as spare cords 400 or empty shopping bags 402 can be stored inconspicuously until needed.

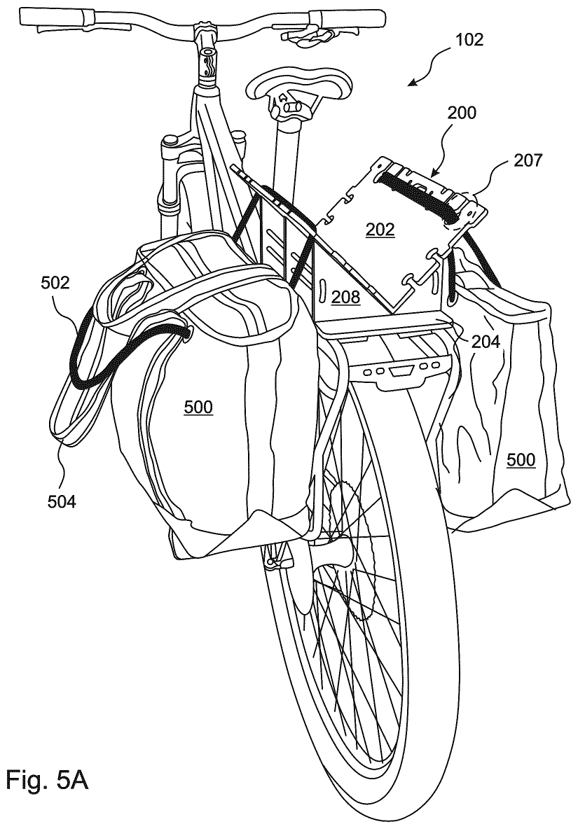

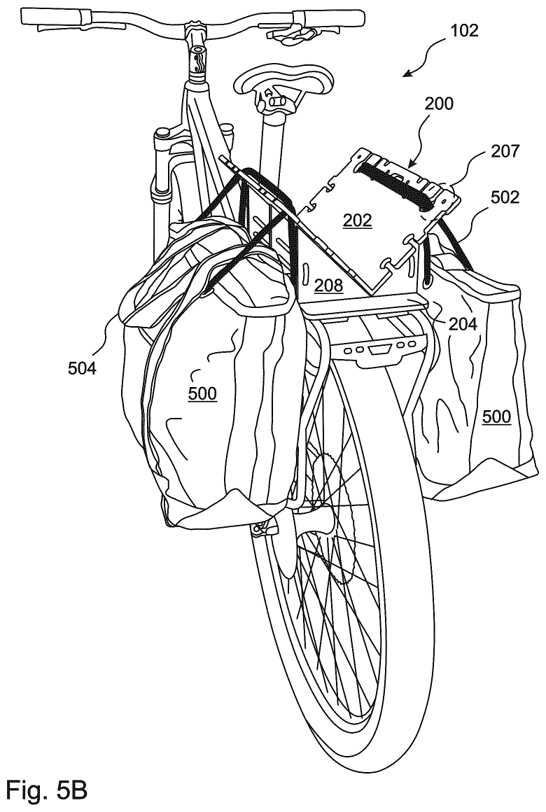

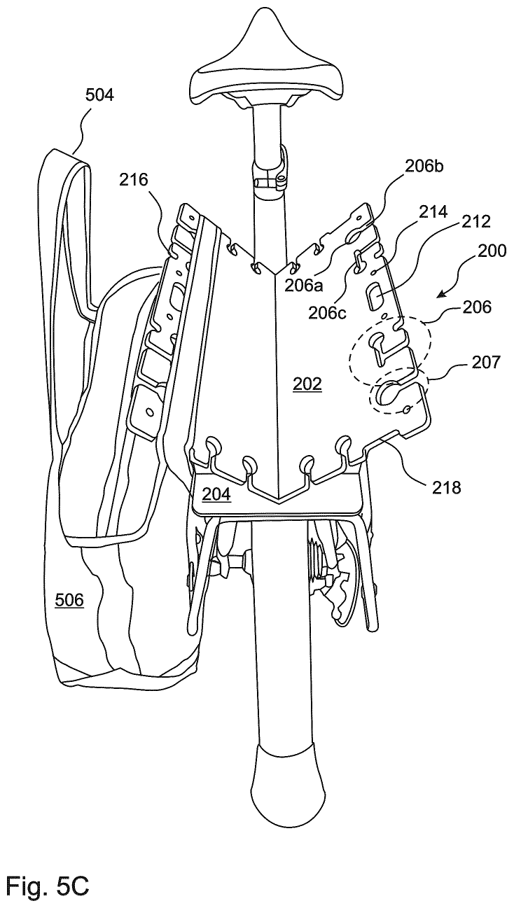

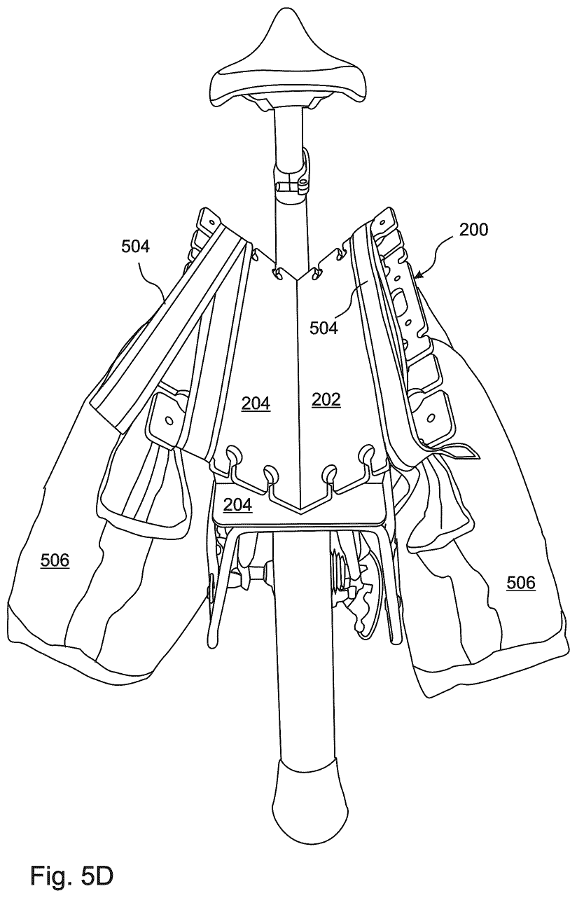

The plurality of openings 206, 207, 212, 214 and notches 216, 218 that are included in the exemplary embodiment of FIGS. 2A-4 are highly versatile for attaching various types of cargo to the carrier 200. FIGS. 5A-5B illustrate a first approach for hanging tote bags from the side panels 202. This approach assumes that the tote bags 500 include heavy cordage lines 502 specifically intended for hanging the tote bags from the disclosed cargo carrier 200, which are in addition to, and shorter than, the carrying handles 504 that are intended for manually carrying the bags 500. According to this approach, with further reference to FIG. 2C, the cordage lines 502 are inserted through the vertical slots 206b into the holes 206a of the outer openings 207. FIG. 5A shows one of the bags 500 fully attached to the cargo carrier 200, while the other bag 500 is in the process of being attached, having only one of its cordage lines 502 inserted in the openings 207. In FIG. 5B, both bags 500 are fully attached to the cargo carrier 200.

FIGS. 5C and 5D illustrate a second approach for hanging tote bags 506 from the side panels 202. In this example, the tote bags 506 do not include separate cordage lines 502. Instead, the bags 506 are suspended from their carrying handles 504. Due to the longer lengths of the carrying handles 504, they are extended to surround the side panels 202, and are positioned in the wide notches 218 that are provided on the sides of the side panels 202. In FIG. 5C, a single tote bag 506 is in the process of being suspended from one of the side panels 202, being illustrated with only one of its carrying handles 504 attached to the cargo carrier 200, while in FIG. 5D, one bag 506 is fully suspended from the cargo carrier 200, while the other bag 506 is shown in the process of being suspended, having one of its carrying handles 504 fully suspended, and the other carrying handle 504 in the process of being attached to the cargo carrier 200.

While FIGS. 5A-5D illustrate the suspending of an exemplary type of fabric tote bags 500, 506, these approaches are equally applicable to suspending other types of cargo, such as a paper, plastic, nylon, or canvas bags, such as bags provided by a grocery store or other retailer. Depending on the lengths of the cordage lines 502 or carrying handles 504, the center of mass of the cargo can be nearly even with the horizontal base 204 of the cargo carrier 200, or well below the horizontal base 204 of the cargo carrier 200, as shown in the figures, thereby minimizing any unbalancing of the bicycle 102 during turns and other tipping events, and eliminating, in many cases, any need to transfer newly purchased items from the retailer's bags to a separate, specially designed cargo carrier.

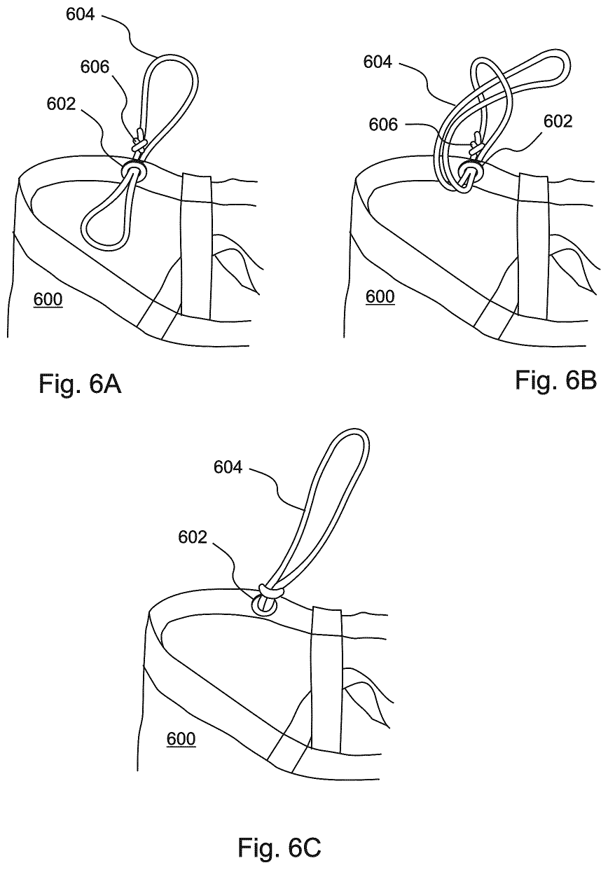

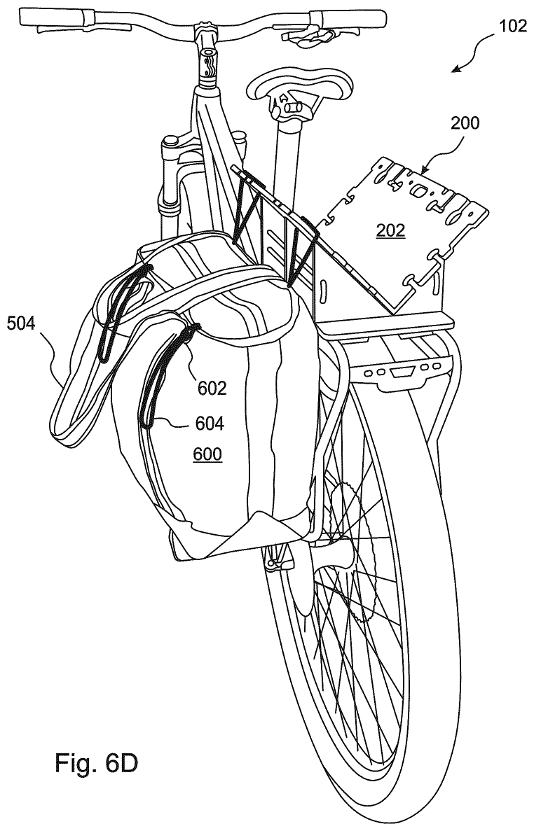

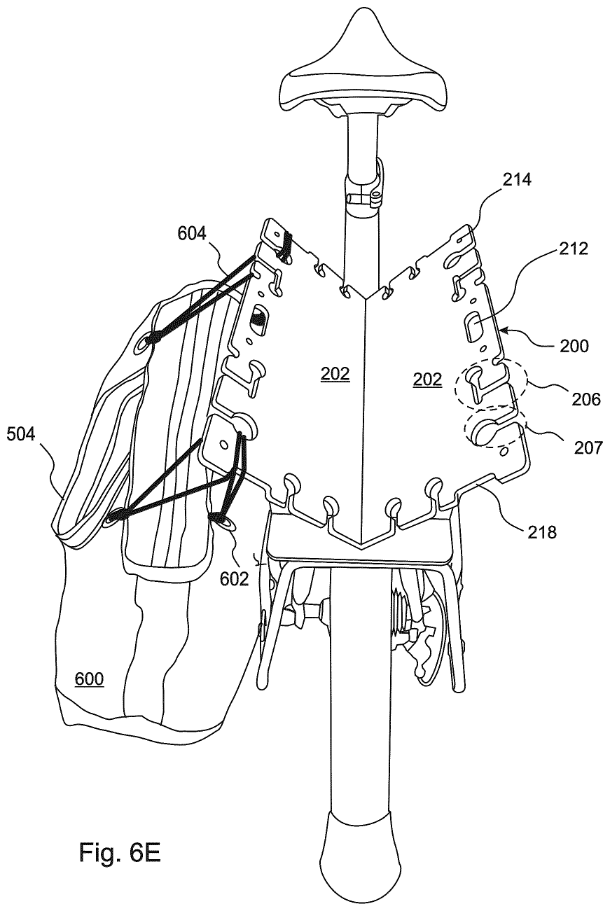

With reference to FIGS. 6A-6E, if a carrying bag 600 lacks carrying handles, the carrying handles are too long or too short, or it is otherwise not convenient to suspend the bag 600 by its carrying handles, holes surrounded by gromets 602 can be provided near the top of the bag 600, and the bag 600 can be suspended from the cargo carrier 200 by a separate cord 604 threaded through the grommets, such as by twine, or by a synthetic braided or nylon cord terminated by a knot or by a ball.

In FIGS. 6A-6E, the bag 600 comprises grommeted holes 602. This can occur, for example, if a user brings his/her own bag to a retail establishment and uses the bag to carry purchased goods. In some embodiments, a bag 600 is provided with grommeted holes 602 or other suspension features specifically to enable the bag to be conveniently used with an embodiment of the disclosed cargo carrier 200. However, unlike saddle bags or panniers, bags specifically intended for use with the present invention can be configured in a similar manner to conventional shopping bags, and used as such. Accordingly, embodiments do not require transfer of purchased goods to a separate, dedicated saddle bag or pannier for transport with the disclosed cargo carrier 200.

In FIGS. 6A-6E, the bag 600 is attached to the cargo carrier 200 by cords that are tied into loops by knots 606. FIG. 6A shows a loop of the cord 604 inserted through a grommeted hole 602 provided in the bag 600. In FIG. 6B, one end of the loop of cord 604 has been pulled through the other, and in FIG. 6C, the loop of cord 604 has been pulled into tight attachment with the bag 600 via the grommeted hole 602. FIG. 6D shows the bag 600 partially installed, being suspended from a side panel 202 of the cargo carrier 200 by one such cord 604, and FIG. 6E shows the bag 600 fully installed, being suspended by two such cords 604. It can be seen in FIG. 6E that the cords 604 are looped between the outer openings 207 and the side notches 218.

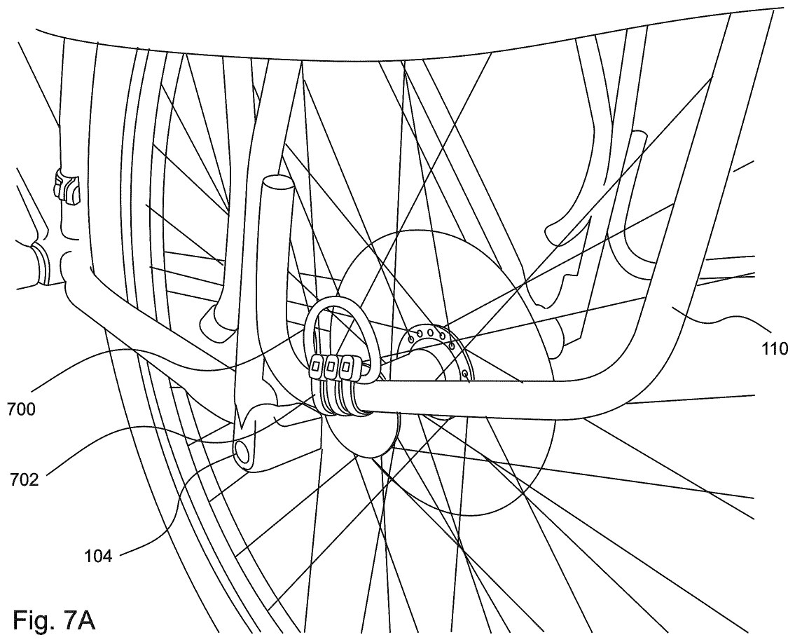

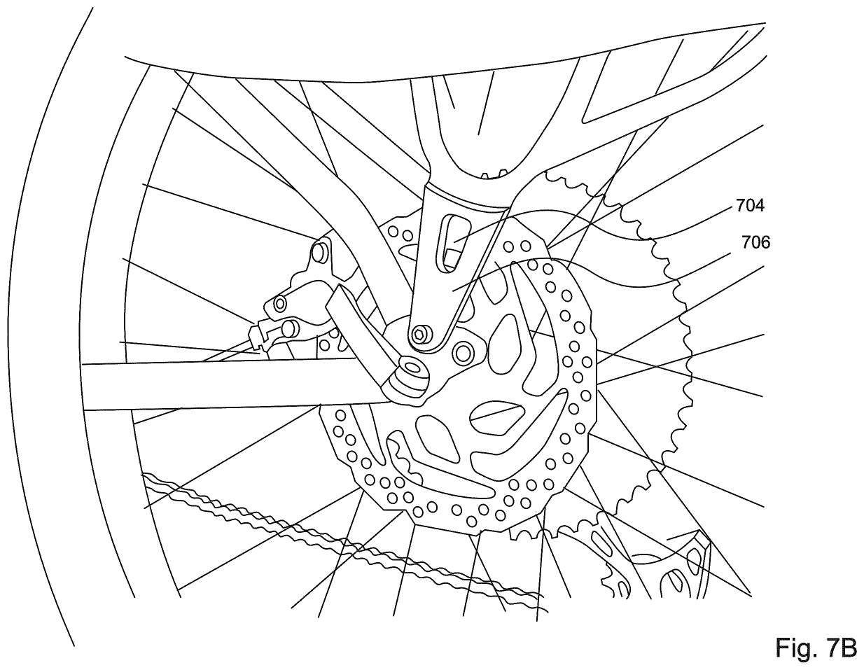

With reference to FIG. 7A, embodiments of the present invention further include an anchoring loop 700 that is attached to the bicycle 102 near the rear axle 104. In the illustrated embodiment, the anchoring loop 700 is attached by “cable tie” straps 702 to one of the struts 110 of the conventional bicycle cargo carrier 100 upon which an embodiment 200 of the invention has been attached. In similar embodiments, anchoring loops 700 are attached on both sides of the bicycle. Some embodiments comprise more than one anchoring loop 700 on the same side of the bicycle. With reference to FIG. 7B, in other embodiments an opening 704 is provided on a base plate 706 of the cargo carrier 200 near where the cargo carrier 200 is attached to the hub of the rear wheel.

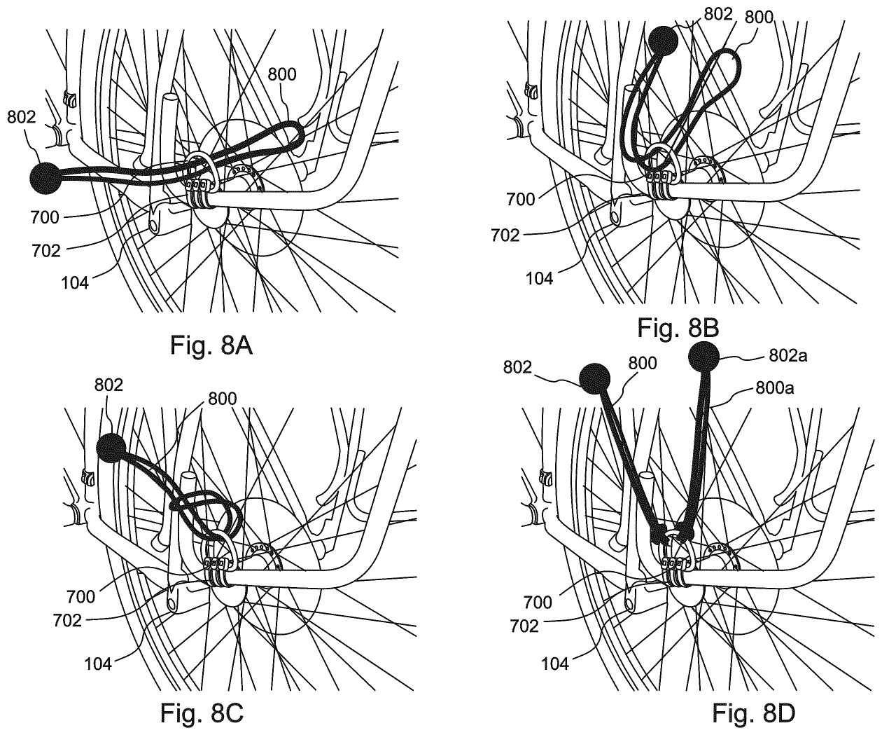

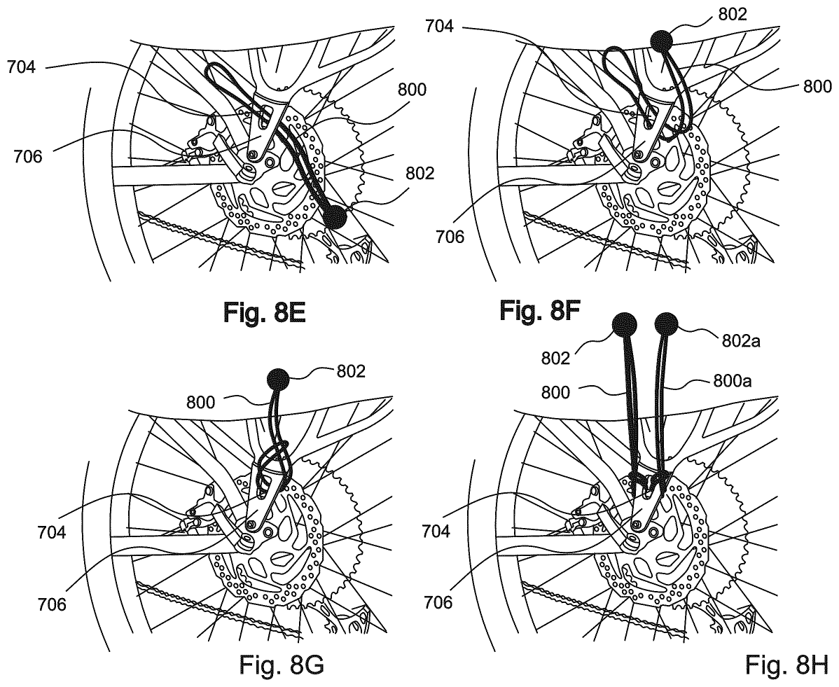

FIGS. 8A-8D illustrate attachment of a cord 800 that is terminated by a ball 802 to the anchoring loop 700 of FIG. 7A. In FIG. 8A, the loop of the cord 800 is inserted through the anchoring loop 700. In FIG. 8B, the ends of the cord 800 are folded toward each other. In FIG. 8C, the ball 802 of the cord 800 has been inserted through the anchoring loop, and in FIG. 8D the cord 800 has been pulled into tightened attachment to the anchoring loop 700, and a second cord 800a terminated by a ball 802a has also been attached to the anchoring loop 700.

FIGS. 8E-8H illustrate attachment of a cord 800 that is terminated by a ball 802 to the opening 704 in the base plate 706 of FIG. 7B. In FIG. 8E, the loop of the cord 800 is inserted through the opening 704. In FIG. 8F, the ends of the cord 800 are folded toward each other. In FIG. 8G, the ball 802 of the cord 800 has been inserted through the anchoring loop 700, and in FIG. 8H the cord 800 has been pulled into tightened attachment to the base plate 706, and a second cord 800a terminated by a ball 802a has also been attached to the base plate 706.

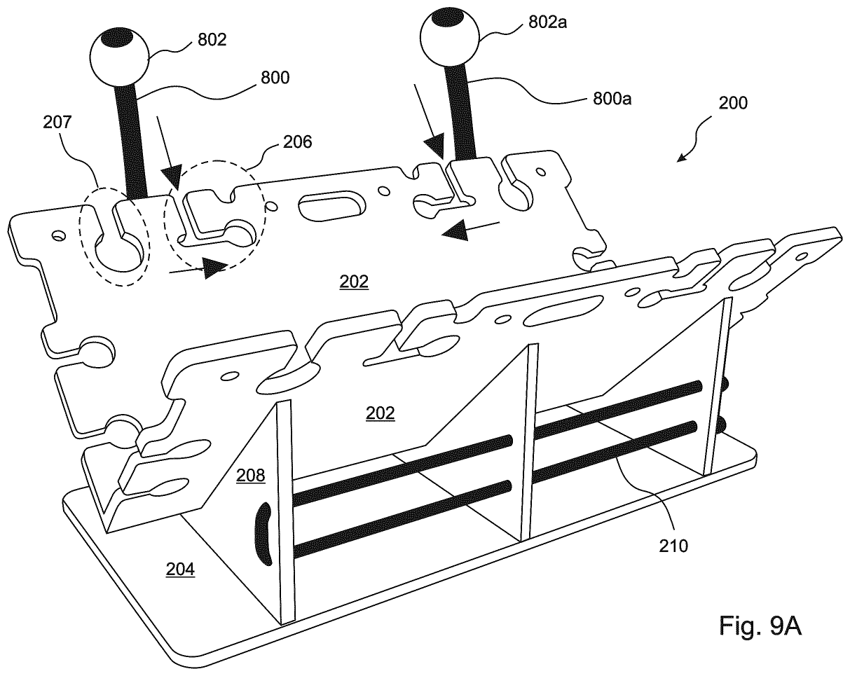

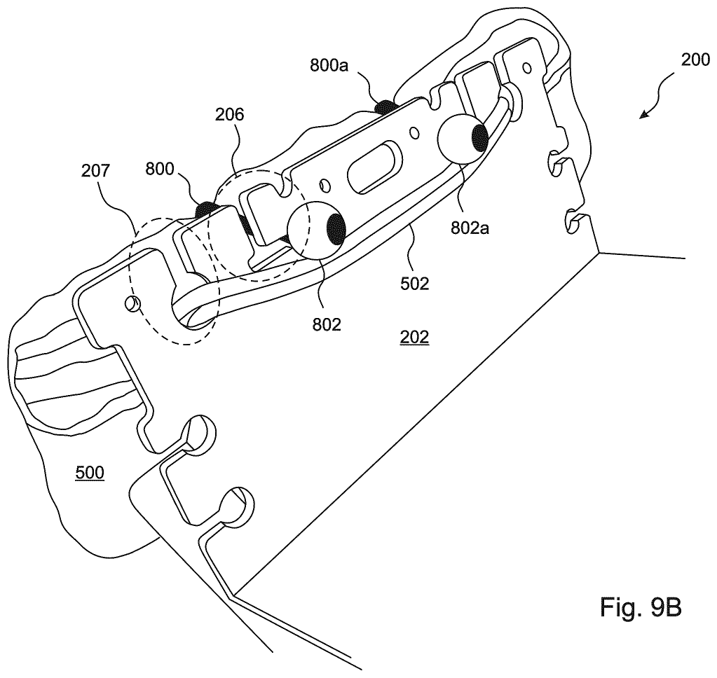

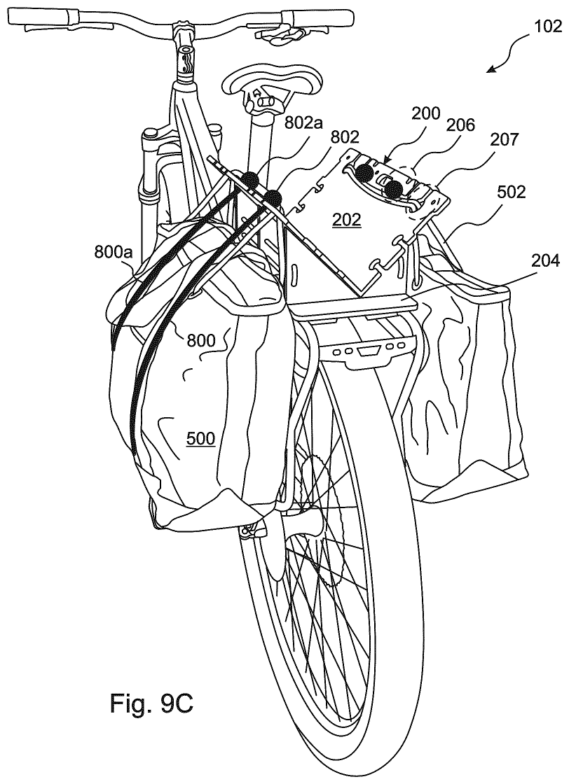

FIGS. 9A-9C illustrate attachment of the two cords 800, 800a of either FIG. 8D or FIG. 8H to the cargo carrier 200 of the exemplary embodiment. FIG. 9A illustrates insertion of the cords 800, 800a into two of the openings 206 by inserting them through the vertical 206b and horizontal 206c slots to the holes 206a. FIG. 9B shows the resulting positions of the balls 802, 802a of the cords 800, 800a. In FIG. 9C, it can be seen that the bags 500 of FIGS. 5A and 5B are suspended from the cargo carrier 200 by their cordage lines 502, which are inserted into the outer two openings 207 of the cargo carrier 200, and further supported and held close to the sides of the cargo carrier 200 by the cords 800 of FIGS. 9A and 9B that extend from the anchoring loop 702 or base plate 706.

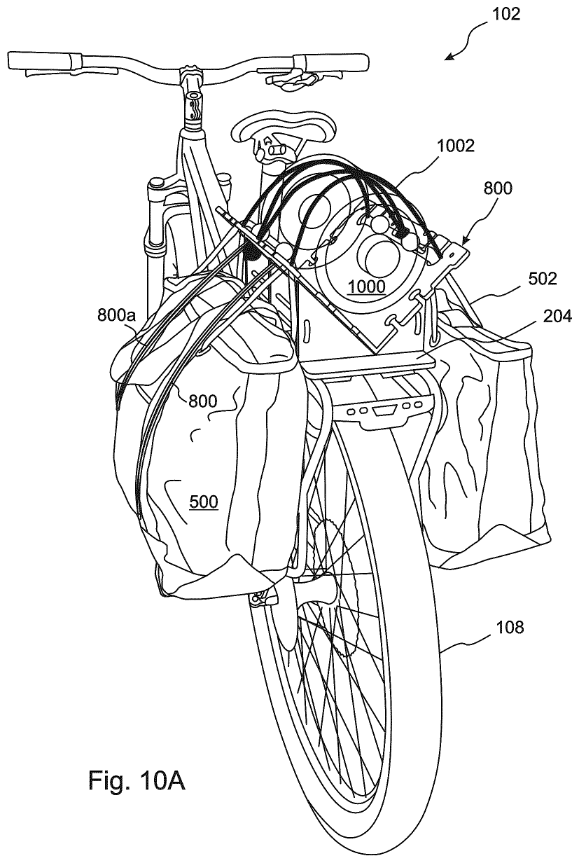

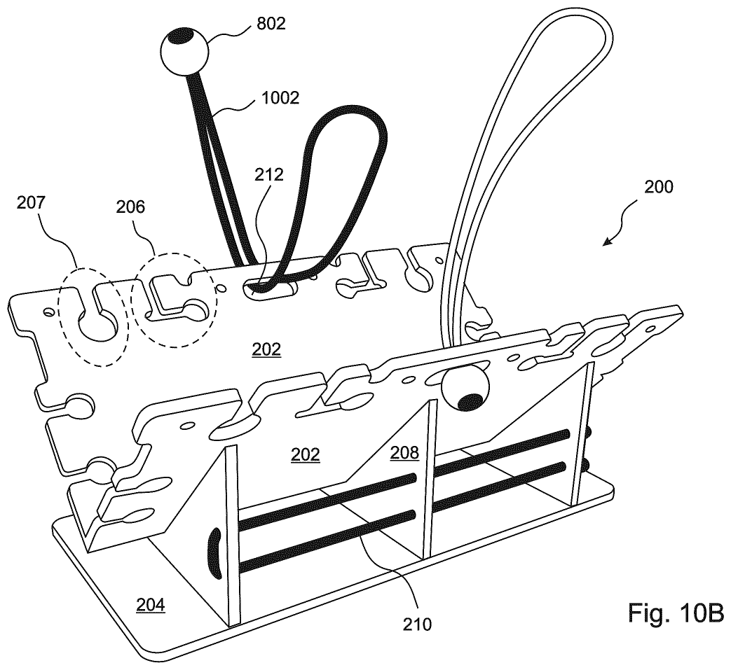

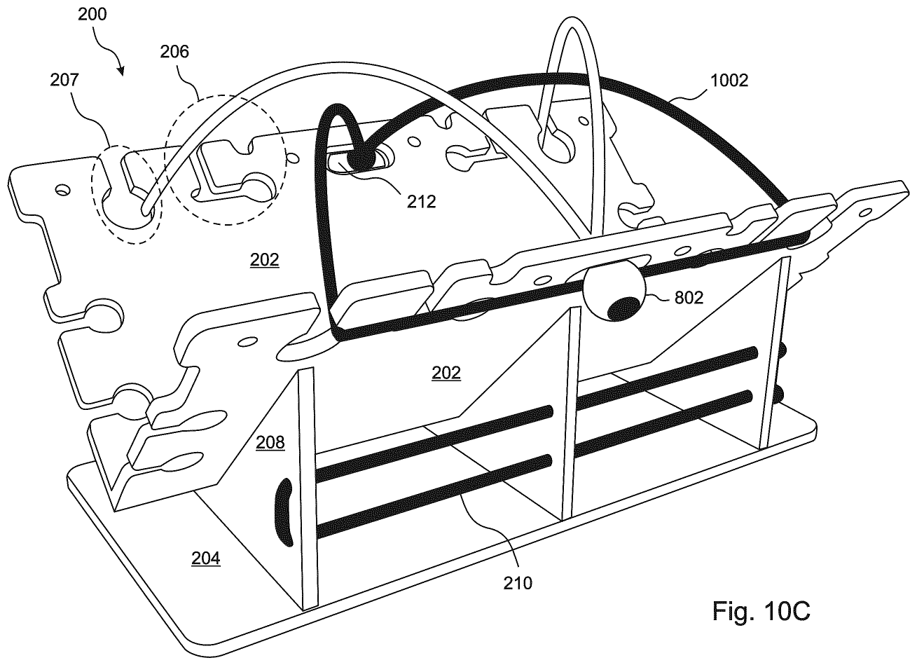

FIG. 10A illustrates an embodiment that is similar to the embodiment of FIGS. 9A-9C, except that additional cargo, namely a large water bottle 1000, has been stowed between the side panels 202 above the carrier base 204 and fixed in place by two additional bungee cords 1002. While the center-of-mass of the added cargo 1000 is located above the carrier base 204, the V-shape between the side panels 202 naturally maintains the cargo 1000 centered over the rear wheel 108 of the bicycle 102, and prevents the cargo 1000 from shifting away from the centerline of the bicycle 102 even when the bicycle 102 is turning or otherwise tipping. FIGS. 10B and 10C illustrate how the additional bungee cords 1002 are attached to the cargo carrier 200 in the illustrated embodiment. With reference to FIG. 10b, the loops of the bungee cords 1002 are inserted inwardly through the large, oval, central openings 212, so that the balls 802 at the ends of the cords 1002 are pulled tight against the large openings 212. With reference to FIG. 10C, the loops 1002 are then drawn across the cargo (not shown in FIGS. 10B and 10C), and inserted into the two outer openings 207 on the opposing sides.

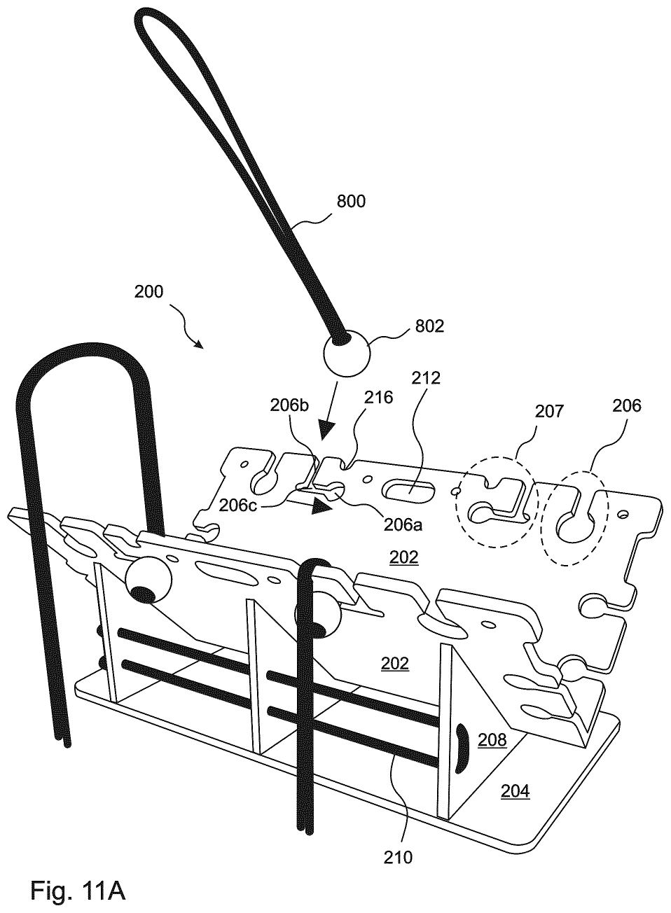

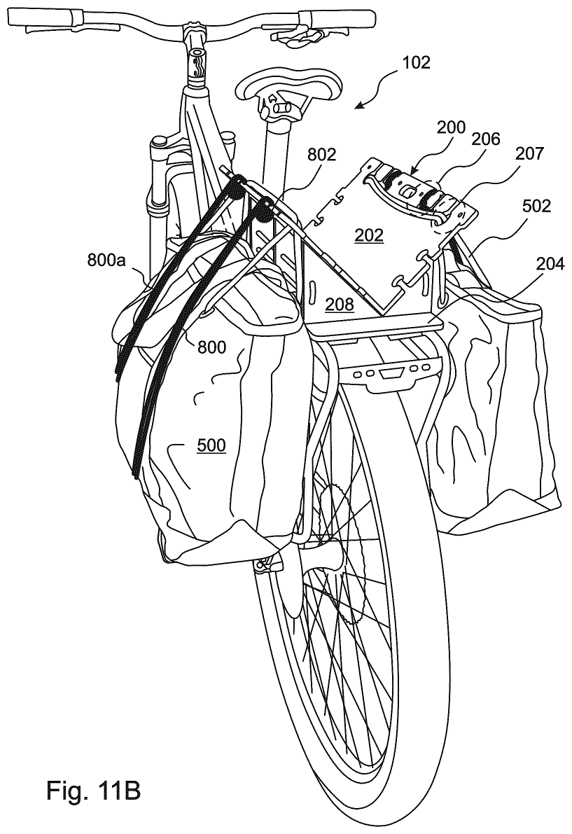

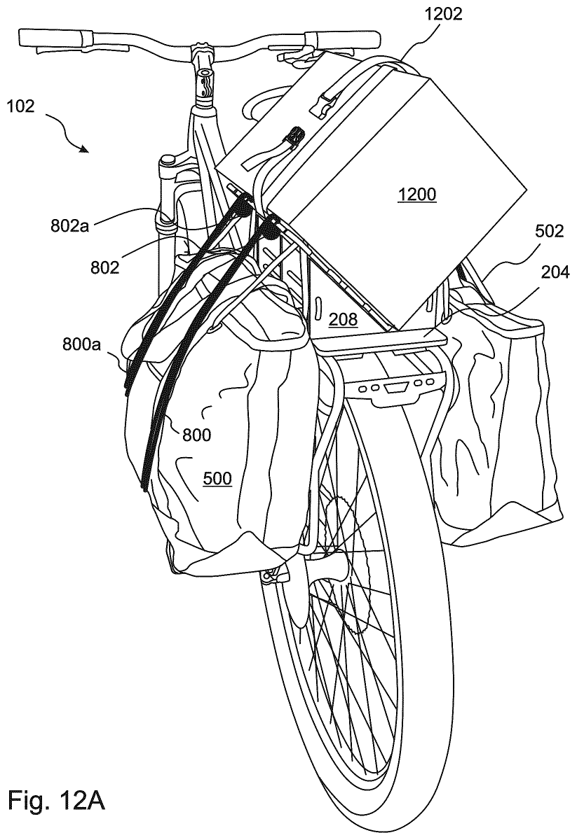

In FIG. 10A, it can be seen that the balls 802 at the ends of the downwardly directed bungie cords 800, 800a extend into a space between the side panels 202 of the cargo carrier 200, and that their presence is accommodated by the round shape of the large bottle 1000. With reference to FIG. 11A, when a square box (not shown in FIG. 11A) or other cargo is carried between the side panels 202 of the cargo carrier 200 such that there is no space between the side walls and the cargo to accommodate the balls 802 of the bungee cords 800, then the cords 800 can be attached to the carrier 200 in an “inverted” configuration. In FIG. 11A, three bungee cords 800 are shown in three different stages of attachment. The uppermost bungee cord 800 is shown approaching one of the inner openings 206 on the side panel 202 of the cargo carrier 200, where it will enter the vertical slot 206b and the traverse the horizontal slot 206c to reach the hole 206a.

The bungee cord 800 in the lower left region of the drawing is shown after the cord 800 has been inserted in to the opening 206, showing that the ball 802 is held against the outer surface of the side panel 202, and showing the cord 800 curved outward over the upper edge of the cargo carrier side panel 202. The lower right bungee cord 800 is shown in a fully deployed configuration, where the bungee cord 800 has been placed in one of the notches 216 provided on the upper edge of the cargo carrier side panel 202. It can be seen in FIG. 11A that the notch 216 will restrain the cord 800 from sliding sideways along the upper edge of the cargo carrier side panel 202. FIG. 11B is a rear view of an embodiment similar to FIG. 9C, but wherein the downward directed bungee cords 800, 800a are attached to the cargo carrier 200 in the inverted manner of FIG. 11A.

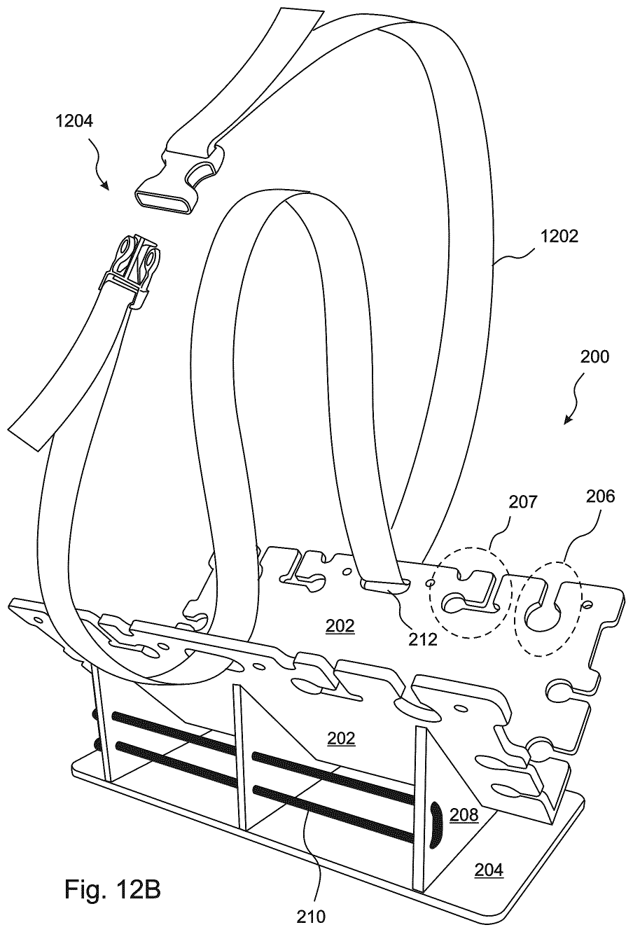

With reference to FIG. 12A, in embodiments the side panels 202 are joined at a right angle. This can be advantageous for efficiently carrying a box 1200 or other cargo that comprises walls meeting at right angles. As can be seen in FIG. 12A, the carrying space between the side panels 202 is efficiently filled by the box 1200, and the box 1200 is held rigidly above the centerline of the bicycle. The bungee cords 800 are attached to the side panels 202 of the cargo carrier 200 in an inverted configuration, as illustrated in FIGS. 11A-11C, so that the balls 802 of the bungee cords 800 do not interfere with the seating of the box 1200 between the side panels 202. It can be seen in the figure that the box 1200 is held in place by a strap 1202, which is wound twice around the box 1200. This method of attachment is illustrated in detail in FIG. 12B. According to this approach, the strap is inserted through the large central openings 212 in the two side panels 202 of the cargo carrier 200. The segment of the strap 1202 that extends between the two openings 212 is lifted up, and the box 1200 (not shown in FIG. 12B) is inserted under it. The two ends of the strap 1202 are then extended over the box 1200 and connected together by a buckle 1204, hook-and-loop fastening, or by other means as are known in the art.

In embodiments, the juncture of the side panels 202 is raised above the base 204 of the cargo carrier 200, thereby providing a space through which a strap 1202, or other attachment apparatus, such as a rope or bungee, can be extended, so that it loops entirely about the side panels 202 and the cargo (not shown).

While the invention has been described and illustrated herein with reference to an exemplary embodiment having a certain pattern of openings, slots, and notches, It will be understood that many other configurations of openings, slots, and notches fall within the scope of the present invention.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A cargo carrier that is attachable to a rear-wheel rack of a bicycle, the cargo carrier comprising:
a horizontal base configured for attachment thereof to the rear-wheel rack;
longitudinal left and right side panels extending obliquely and symmetrically upward from a central juncture between lower edges thereof, a V-shaped carrying space being formed between the side panels, the central juncture extending longitudinally in vertical alignment with a rear wheel of the bicycle; and
a plurality of upper openings provided proximate upper edges of the left and right side panels.

2. The cargo carrier of claim 1, wherein the left and right side panels are inclined from vertical by angles of 45 degrees and −45 degrees, respectively, thereby forming a right angle at the central juncture therebetween.

3. The cargo carrier of claim 1, wherein at least one of the upper openings comprises a hole and a passage that extends from the hole to the upper edge of the left side panel or the right side panel.

4. The cargo carrier of claim 1, wherein at least one of the upper openings comprises:
a hole;
a horizontal passage having a proximal end extending horizontally from the hole; and
a vertical passage extending vertically from a distal end of the horizontal passage to the upper edge of the left side panel or the right side panel.

5. The cargo carrier of claim 1, wherein at least one of the upper openings is a notch extending downward from the upper edge of the left side panel or the right side panel.

6. The cargo carrier of claim 1, further comprising at least one side opening provided on at least one of a front side edge and a rear side edge of the left side panel or the right side panel.

7. The cargo carrier of claim 1, wherein the upper openings comprise a longitudinally extending oval penetration proximate the upper edge of the right side panel or the left side panel.

8. The cargo carrier of claim 1, wherein the upper openings comprise a plurality of pairs of identically shaped, horizontally aligned openings provided proximate the upper edges of the left and right side panels.

9. The cargo carrier of claim 1, wherein the central juncture is vertically spaced above the horizontal base, forming a gap therebetween.

10. The cargo carrier of claim 1, further comprising at least two longitudinally spaced apart left side supports extending between the left side panel and the horizontal base, and two longitudinally spaced apart right side supports extending between the right side panel and the horizontal base.

11. The cargo carrier of claim 10, wherein each of the side supports comprises at least one hole proximate an outer edge thereof, and wherein the cargo carrier further comprises a side cord inserted through said holes and extending longitudinally therebetween, the side cord being thereby positioned above the horizontal base and latitudinally spaced apart from the side panels.

12. The cargo carrier of claim 1, further comprising an anchoring loop configured for attachment thereof to a side of the bicycle proximate a rear axle thereof, the anchoring loop being configured for attachment thereto of a cord extending upward therefrom to one of the openings in the left or the right side panel.

13. The cargo carrier of claim 1, further comprising an anchoring base plate penetrated by a base plate opening and configured for attachment thereof to a side of the bicycle proximate a rear axle thereof, the anchoring base plate being configured for attachment thereto of a cord extending upward therefrom to one of the upper openings on the left or the right side panel.

14. A method of transporting cargo on a bicycle to a destination, the method comprising:
providing a bicycle having a rear wheel rack mounted thereto;
providing a cargo carrier according to claim 1;
attaching the horizontal base of the cargo carrier to the rear wheel rack;
attaching the cargo to the cargo carrier; and
riding by a user of the bicycle to the destination.

15. The method of claim 14, wherein attaching the cargo to the cargo carrier comprises:
placing the cargo in a bag; and
attaching the bag to at least two selected openings included in the upper openings, all of the selected openings being provided on the left side panel, or all of the selected openings being provided on the right side panel.

16. The method of claim 15, wherein attaching the bag to the selected openings comprises inserting at least one looped handle of the bag into the selected openings.

17. The method of claim 15, wherein attaching the bag to the selected openings comprises attaching at least one cord to the bag and to at least one of the selected openings.

18. The method of any of claim 15, wherein the cargo carrier comprises an anchoring loop or an anchoring base plate attached to a side of the 2 bicycle proximate a rear axle thereof, and wherein attaching the bag to the selected openings comprises attaching a cord to the anchoring loop or anchoring base plate, extending the cord over the bag, and attaching the cord to one of the selected openings.

19. The method of claim 14, wherein attaching the cargo to the cargo carrier comprises placing the cargo into the V-shaped carrying space between the side panels, extending a cord or strap over the cargo, and attaching the cord or strap to the cargo carrier.

20. The method of claim 19, wherein attaching the cord or strap to the cargo carrier comprises one of:
attaching ends of the cord or strap to at least one of the upper openings provided on the left side panel and at least one of the upper openings provide on the right side panel; and
extending the cord or strap through a space provided between the central juncture and the horizontal base, and attaching the ends of the cord or strap to each other, such that the cord or strap encircles the side panels and the cargo.
